(19) United States
(12) Patent Application Publication
(10) Pub. No.: US 2023/0234494 A1
(43) Pub. Date: Jul. 27, 2023

(54) OFF-ROAD VEHICLE

(71) Applicant: INEOS AUTOMOTIVE LIMITED, Lyndhurst (GB)

(72) Inventor: Paul Dodsworth, Böblingen (DE)

(73) Assignee: INEOS AUTOMOTIVE LIMITED, Lyndhurst (GB)

(21) Appl. No.: 18/009,229

(22) PCT Filed: Jun. 9, 2021
(86) PCT No.: PCT/GB2021/051436

§ 371 Date: Dec. 8, 2022

(30) Foreign Application Priority Data
Jun. 9, 2020 (GB) 2008700.3
Jun. 9, 2020 (GB) 2008711.0
Jun. 9, 2020 (GB) 2008729.2

(51) Int. Cl. B60P 7/08; B62D 29/00; B62D 25/06; B60R 9/02; B60R 19/03; B60R 9/04; B60J 5/04

(52) U.S. Cl. CPC B60P 7/0815; B62D 29/005; B62D 25/06; B60R 9/02; B60R 19/03; B60R 9/04; B60J 5/0426

(57) ABSTRACT

The present disclosure relates to a recessed roof panel (100) for a vehicle, the recessed roof panel comprising a housing 101) with a basin (102) and a lip portion (104) at least partly surrounding the basin, wherein the housing is configured such that, in use, the basin (102) extends towards an interior of a vehicle when the lip portion (102) abuts against an exterior surface of a vehicle roof.

### BACKGROUND OF THE INVENTION

The present disclosure relates to a recessed roof panel for a vehicle, particularly but not exclusively, for an off-road vehicle. Other aspects of the present disclosure relate to a vehicle, particularly but not exclusively, an off-road vehicle comprising a recessed roof panel.

Since the invention of the first automobile by Henry Ford, a large variety of different types of ground vehicles have been developed. One such vehicle type is the off-road vehicle or sometimes referred to as a 4×4 vehicle. Off-road vehicles are specifically designed to navigate difficult terrains, such as steep slopes, rocky grounds, or even riverbeds. These vehicles are used by a variety of operators, such as safari tour guides, fishermen or even farmers, who can use off-road vehicles for a variety of agricultural tasks. Generally, in order to navigate difficult terrains, off-road vehicles are characterised by having large tyres with deep, open treads, a flexible suspension and a large ground clearance.

In recent years, the look and feel of off-road vehicles has become attractive to a wider range of vehicle customers. Oftentimes, such customers do not have a need for the off-road capabilities and the stability of such vehicles. Rather, this customer segment appreciates the large storage capabilities and the better overview larger off-road vehicles have to offer.

As a consequence of the new demand for off-road vehicles that are adapted for urban use, a large share of off-road vehicle manufacturers have developed their off-roaders to offer more comfort to the customers using these vehicles in urban environments.

Although most of the aforementioned 4×4s still have some off-road capabilities, these can be heavily compromised by additional convenience features, such as a variety of sensitive electronics and aesthetically pleasing interiors.

In view of the above, there is now a demand for more traditional off-road vehicles that are purpose built that work in a variety of difficult terrains, have an exceptionally long service life and are dictated by function rather than form.

The present disclosure also relates to a vehicle, particularly but not exclusively to an off-road vehicle. The vehicle comprises a tie-down system for securing items to the vehicle. Other aspects of the present disclosure relate to a vehicle door.

Since commercialisation of the first automobile, a large variety of different types of vehicles have been developed. One such vehicle type is the off-road vehicle or sometimes referred to as a 4×4. Off-road vehicles are specifically designed to navigate difficult terrains, such as steep slopes, rocky grounds, or even riverbeds. These heavy duty vehicles are used by users with various different requirements, such as safari tour guides, fishermen, or farmers. Generally, in order to navigate difficult terrains, off-road vehicles are characterised by having large tyres with deep, open tread, a flexible suspension and large ground clearance.

In recent years, the look and feel of off-road vehicles has become attractive to a wider range of vehicle customers. Oftentimes, such customers do not have a need for the “off-road capability” and the stability of such vehicles. Rather, this customer segment largely utilises 4×4s in urban environment and thus appreciates the large storage capabilities and the improved field of vision larger off-road vehicles have to offer. As a consequence of the new demand for off-road vehicles that are specifically made for urban use, a large share of off-road vehicle manufacturers have developed their 4×4s to offer more comfort to the customers using these vehicles in urban environments, i.e. on roads. Although most of the aforementioned vehicles still have some off-road capabilities, these can be heavily compromised by the additional convenience features, such as a variety of sensitive electronic components and aesthetically pleasing exterior/interior surfaces.

In view of the above, there is now a demand for more traditional off-road vehicles that are purpose-built and work in a variety of difficult terrains, have an exceptionally long service life and are dictated by function rather than form.

One capability that is expected of a purpose-built off-roader is the ability to safely transport heavy objects in various shapes and sizes. Some known vehicles offer roof rails for attaching objects to the roof of the vehicle. Others include tow bars for towing trailers that may be used to transport heavy objects. However. of course, not all terrains allow for a trailer to be towed behind the vehicle or loading heavy objects onto the roof of a vehicle is not always feasible. Alternative transport solutions are, therefore, required.

The disclosure also relates to a multi-part bumper for a vehicle, particularly, but not exclusively, to a multi-part bumper for off-road vehicles. Another aspect of the present disclosure relates to a vehicle comprising the multi-part metal bumper.

Since commercialisation of the first automobile, a large variety of different types of vehicles have been developed. One such vehicle type is the off-road vehicle or sometimes referred to as a 4×4. Off-road vehicles are specifically designed to navigate difficult terrains, such as steep slopes, rocky grounds, or even riverbeds. These heavy duty vehicles are used by users with various different requirements, such as safari tour guides, fishermen, or farmers. Generally, in order to navigate difficult terrains, off-road vehicles are characterised by having large tyres with deep, open tread, a flexible suspension and large ground clearance.

In recent years, the look and feel of off-road vehicles has become attractive to a wider range of vehicle customers. Oftentimes, such customers do not have a need for the “off-road capability” and the stability of such vehicles, Rather, this customer segment largely utilises 4×4s in urban environment and thus appreciates the large storage capabilities and the improved field of vision larger off-road vehicles have to offer. As a consequence of the new demand for off-road vehicles that are specifically made for urban use, a large share of off-road vehicle manufacturers have developed their 4×4s to offer more comfort to the customers using these vehicles in urban environments, i.e. on roads. Although most of the aforementioned vehicles still have some off-road capabilities, these can be heavily compromised by the additional convenience features, such as a variety of sensitive electronic components and aesthetically pleasing exterior/interior surfaces.

In view of the above, there is now a demand for more traditional off-road vehicles that are purpose-built and work in a variety of difficult terrains, have an exceptionally long service life and are dictated by function rather than form.

Reliable bumpers are a key part of a purpose-built off-road vehicle. Bumpers fulfil a protective function in absorbing the impact of collisions (e.g. by incorporating springs). When navigating uneven and/or overgrown terrain, impact of the bumpers with plants or rocks is common. Accordingly, more traditional off-road-vehicles included metal bumpers that offered suitable impact resistance. Such metal bumpers typically consisted of a solid metal bar often welded to the front of a vehicle chassis.

As the technology for producing plastic developed, vehicle manufacturers transitioned from metal bumpers to plastic bumpers. This is because the use of plastic in bumpers allowed for more flexible manufacturing and offered greater design freedom than the use of metal.

However, plastic bumpers are more fragile than metal bumpers. Manufacturers have worked on improving plastic bumpers and reinforcing them to increase their durability.

In view of the above, there is a need for a bumper that exhibits high strength characteristics and, at the same time, offers a great deal of design freedom.

It is aim of the present invention to solve or at least ameliorate one or more problems of the prior art.

### SUMMARY OF THE INVENTION

Aspects and embodiments of the disclosure provide a vehicle and parts thereof as claimed in the appended claims.

According to one aspect of the present disclosure, there is a recessed roof panel for a vehicle, the recessed roof panel comprising a housing with a basin and a lip portion at least partly surrounding the basin, wherein the housing is configured such that, in use, the basin extends towards an interior of a vehicle when the lip portion abuts against an exterior surface of a vehicle roof.

The housing may be made of plastic material.

The recessed roof panel may be configured to be removably attached to a vehicle.

In another embodiment, the recessed roof panel comprises a sealing member arranged on the lip portion in such a way that, in use, the sealing member is located between the lip portion and an exterior surface of a vehicle.

The recessed roof panel may comprise at least one connector piece, particularly a metal connector piece, attached to the basin of the housing.

In another embodiment, the connector piece comprises one or more fastening members extending through the basin, said one or more fastening members being configured for attachment to a frame of a vehicle.

In another embodiment, the connector piece is received within the basin and sized such that no part of the connector piece protrudes over the lip portion of the housing.

In another embodiment, the basin has a concave surface and a convex surface arranged on opposite sides of the basin, and wherein the connector piece is connected to the concave surface of the basin.

In another embodiment, the basin comprises reinforcement ribs located on the convex surface of the basin.

In another embodiment, the basin comprises one or more flange portions configured to abut against a corresponding frame of a vehicle, when in use, the one or more flange portions being arranged on the convex surface of the basin, opposite to the at least one connector piece.

The connector piece may comprise one or more tie-down members.

The one or more tie-down members may be clamps, studs, or lugs.

The recessed roof panel may comprise a removable bar received within the basin.

In another embodiment, the recessed roof panel comprises at least two connector pieces attached to the basin of the housing, wherein the removable bar is removably connected to the at least two metal connector pieces.

According to another aspect of the present disclosure, there is provided a vehicle comprising a vehicle roof and at least one of the above recessed roof panels, the recessed roof panel being removably connected to the vehicle roof.

The recessed roof panel may be connected to a side edge of the vehicle roof.

In another embodiment, the vehicle roof comprises an opening for receiving the recessed roof panel, and wherein the recessed roof panel is connected to the opening such that the basin of the roof panel recess extends into the vehicle and the lip portion extends around the circumference of the opening and abuts against an exterior surface of the vehicle roof.

In another embodiment, the vehicle comprises one or more spring clips attached to an interior surface of the basin and adapted to bias the lip portion against the exterior surface of the vehicle.

In another embodiment, the vehicle comprises a reinforcement structure that is arranged between an exterior surface and an interior surface of the vehicle roof, and wherein the at least one connector piece is removably attached to the reinforcement structure.

According to another aspect of the present disclosure, there is provided a vehicle comprising a tie-down system for removably securing items to the vehicle, the tie-down system being arranged on an external surface on a side, front, and/or rear of the vehicle and at least partly connected to a reinforcement structure that is arranged between the exterior surface and an internal surface of the vehicle.

In an embodiment, the vehicle comprises a vehicle door, the vehicle door having an interior surface, an exterior surface, and a door cavity located between the interior and the exterior surface of the vehicle door, and wherein the reinforcement structure is arranged within the door cavity.

The tie-down system may be removably connected to the reinforcement structure.

In another embodiment, the reinforcement structure comprises at least one reinforcement plate removably attached between the interior surface and the exterior surface of the vehicle.

In another embodiment, the tie-down system comprises one or more fastening members extending through the exterior surface of the vehicle and through one or more openings of the reinforcement plate.

In another embodiment, the reinforcement structure comprises a first reinforcement plate attached between the interior surface and the exterior surface of the vehicle, the first reinforcement plate comprising a plurality of alignment means for positioning the first reinforcement plate in a predetermined orientation with respect to the exterior surface of the vehicle.

In another embodiment, the alignment means comprise at least two openings adapted to receive a corresponding protrusion arranged between the interior surface and the exterior surface of the vehicle.

The tie-down system may be arranged on an exterior surface of a vehicle door, preferably a vehicle side door.

The tie-down system may protrude from the exterior surface of the vehicle door.

In another embodiment, the tie-down system comprises an elongated tie-down track that extends between a door handle and a door hinge of the vehicle door.

In another embodiment, the vehicle comprises a first tie-down system and a second tie-down system, the first and second tie-down system being vertically spaced from each other, in use.

In another embodiment, the first and second tie-down systems are both arranged on an exterior surface of one vehicle door.

In another embodiment, the tie-down system comprises an elongated tie-down track comprising an elongated tie-down base, the elongated tie-down base including a plurality of insert-openings for introducing tie-down fittings, wherein adjacent insert-openings are connected by slotted sections, the slotted sections having a slot width that is smaller than a diameter of the insert-openings.

In another embodiment, the tie-down system comprises a single mount comprising at least two insert-openings for inserting tie-down fittings, the two insert-openings being connected by a slotted section, the slotted sections having a slot width that is smaller than a diameter of the insert-openings.

The vehicle may be an off-road vehicle.

According to another aspect of the present disclosure, there is provided a vehicle door comprising an exterior surface, an interior surface and a door cavity between the exterior surface and the interior surface, the vehicle door comprising a tie-down system for removably securing items to the vehicle door, the tie-down system being arranged on the exterior surface of the vehicle door and at least partly connected to a reinforcement structure that is arranged within the door cavity.

In another aspect of the present disclosure there is provided a multi-part metal bumper for a vehicle, the multi-part metal bumper being removably connectable to a chassis of a vehicle and comprising a plurality of bumper segments removably connected to each other. The multi-part metal bumper comprising a plurality of bumper segments removably connected to each other allows for a larger variety of manufacturing methods to be employed. In particular, some or all of the bumper segments may be manufactured by cold forming methods, such as stamping or pressing. This allows for the metal bumper to be shaped much like a plastic bumper. The multi-part metal bumper comprising a plurality of bumper segments further advantageously reduces the cost of repairing the bumper since any damaged bumper segment can be selectively removed and non-damaged bumper segments can be retained. Moreover, the multi-part metal bumper being removably connectable to the chassis and comprising a plurality of bumper segments advantageously allows for any one of the bumper segments to be easily replaced and offers users a greater number of possibilities for customising the vehicle. For example, any one of the bumper segments may be replaceable with a thicker, stronger and more durable bumper segment for use of the vehicle in activities such as off-road driving or farming.

In another embodiment, the bumper segments are pressed metal pieces. The bumper segments being pressed metal pieces allows for the bumper segments to be of high quality and durability and made efficiently at a low cost.

In another embodiment, the bumper segments may be made from plate metal. The bumper segments being made from plate metal allows for a variety of sophisticated shapes, as the comparatively thin plate metal is easily deformable compared to more traditional cast iron bumper bars.

In another embodiment, the bumper segments may have a substantially C-shaped cross-section and define a top portion, a middle portion and a bottom portion. The C-shaped cross-section allows for a degree of flexibility of the otherwise very rigid metal bumper. This is particularly beneficial when inadvertently running into objects, such as other cars. In such a case, C-shaped bumper segments may plastically deform more easily than traditional iron bumper bars. The C-shaped cross-section also simplifies the connection of the multi-part metal bumper to the chassis of the vehicle.

In another embodiment, the plurality of bumper segments may comprise three bumper segments. The plurality of bumper segments comprising three bumper segments provides an economical compromise between advantageously reducing the probability that any one bumper segment will be damaged by an impact and minimizing the cost and complexity of manufacturing the multi-part metal bumper, Of course, any number of segments over two is generally feasible.

In another embodiment, the plurality of bumper segments may comprise a central bumper segment, a first side bumper segment, and a second side bumper segment, the first side bumper segment being removably connected to a first end of the central bumper segment and the second side bumper segment being removably connected to a second end of the central bumper segment, the first and second ends of the central bumper segment being arranged on opposite sides of the central bumper segment. The plurality of bumper segments comprising a central bumper segment, a first side bumper segment, and a second side bumper segment advantageously isolates damage caused by frontal impacts and lateral impacts.

In another embodiment, the plurality of bumper segments may be removably connectable to each other and/or the chassis via connector plates.

In another embodiment, at least one of the plurality of bumper segments may comprise a set of connector plates, the set of connector plates comprising a top, middle and bottom connector plates at the top, middle and bottom portions of the bumper segment respectively. Such an arrangement advantageously allows the bumper segments to be more securely connected to each other and the chassis of the vehicle.

In another embodiment, the central bumper segment may comprise longitudinal connector plates distributed along the length of the central bumper segment, the longitudinal connector plates extending from the inside surface of the bottom portion of the central bumper segment at an angle with respect to the surface of the bottom portion such that the longitudinal connector plates are substantially parallel with the top portion of the central bumper segment. Such an arrangement advantageously allows the central bumper segments to be more securely connected to the chassis of the vehicle.

In another embodiment, the multi-part metal bumper may comprise at least one cover element at least partially covering the connector plates of adjacent bumper segments. The at least one cover element advantageously reinforces the connection of the plurality of bumper segments with the chassis/with each other and protects the connector plates from damage.

In another embodiment, each connector plate may comprise at least one fastening hole, wherein the fastening hole of each connector plate receives a fastening element for removably connecting the connector plate to a corresponding connector plate, chassis or cover element.

In another embodiment, a bumper segment may comprise a pair of connector brackets mounted on its top and bottom connector plates, the connector brackets comprising at least one fastening hole, wherein the fastening hole of each connector bracket receives a fastening element for removably connecting the connector bracket to a corresponding cover element. The provision of connector brackets advantageously allows for cover elements to be replaced without replacing the bumper segment or affecting the connection of the bumper segments to each other or to the chassis.

In another embodiment, the central bumper segment may comprise a first set of connector plates at its first end and a second set of connector plates at its second end, wherein the first side bumper segment comprises a third set of connector plates at an end that is adjacent to the central bumper segment, and wherein the second side bumper segment comprises a fourth set of connector plates at an end that is adjacent to the central bumper segment. Such an arrangement where the first and second sets of connectors plates are adjacent to the third and fourth sets of connector plates respectively offers a compact design that advantageously allows for a single cover element to cover more than one connector plate.

In another embodiment, the plurality of bumper segments may be removably connected to each other and/or the chassis via connector plates, wherein the connector plates are overlapping connector plates. The plurality of bumper segments being removably connected to each other via overlapping connector plates advantageously reinforces the connection between the bumper segments. This offers a more stable and secure multi-part metal bumper.

In another embodiment, each of the overlapping connector plates may comprise at least one fastening hole, wherein the fastening holes of overlapping connector plates are aligned to receive a common fastener for removably connecting the overlapping connector plates with each other and/or the chassis.

In another embodiment, the multi-part metal bumper may comprise at least one cover element at least partially covering the overlapping connector plates. The multi-part metal bumper comprising at least one cover element advantageously reinforces the connection of the plurality of bumper segments between each other and protects the connector plates from damage.

In another embodiment, the central bumper segment may comprise a recess for receiving a winch or a winch holder. The recess allows for the winch or winch holder to be partly surrounded by the central bumper segment, thereby improving the stability of the connection between the winch and the multi-part bumper.

In another embodiment, at least one of the plurality of bumper segments may comprise an opening, wherein a grid component is removably received in said opening. In use, the grid may be arranged to extend in a plane that is perpendicular to the direction of travel. The plurality of bumper segments comprising an opening for receiving a grid component advantageously allow for the additional airflow through the multi-part bumper, e.g. for cooling purposes.

In another embodiment, each of the plurality of bumper segments may comprise an opening, wherein a grid component is removably received in each opening. The plurality of bumper segments each comprising an opening for receiving a grid component advantageously increases the airflow.

In another embodiment, the multi-part metal bumper further may comprise a skid plate removably connected to one or more of the plurality of bumper segments. The multi-part metal bumper comprising a skid plate advantageously protects the underside of the vehicle from damage. The skid plate being removably connected to one or more of the plurality of bumper segments advantageously allows for the skid plate to be easily replaced and offers users a greater number of possibilities for customising the vehicle. For example, the skid plate may be replaceable with a thicker, stronger and more durable skid plate for use of the vehicle in activities such as off-road driving or farming.

In another embodiment, the multi-part metal bumper further may comprise a skid plate removably connected to the central bumper segment. The multi-part metal bumper comprising a skid plate removably connected to the central bumper segment advantageously allows for the skid plate to be installed or removed without needing to remove bumper segments other than the central bumper segment.

In another embodiment, the skid plate may comprise a mesh. The skid plate comprising a mesh advantageously allows for additional airflow through the bumper.

In another embodiment, the multi-part metal bumper may further comprise reinforcement elements. The multi-part metal bumper comprising reinforcement elements advantageously improves the durability of the multi-part metal bumper. The reinforcement elements may be attached (e.g. welded) to an internal surface of the multi-part metal bumper.

In another embodiment, each bumper segment may be reinforced by separate reinforcement elements. Each bumper segment being reinforced by separate reinforcement elements advantageously allows for only one bumper segment requiring to be removed in the case of a reinforcement element being damaged.

In another embodiment, the multi-part metal bumper may comprise a pair of wheel arch panels, the wheel arc panels being removably connectable to the plurality of bumper segments.

In another embodiment, the bumper segments may be removably connectable to the front of the vehicle to define a front bumper or removably connectable to the rear of the vehicle to define a rear bumper.

According to another aspect of the present disclosure, there is provided a vehicle, preferably an off-road vehicle, comprising the multi-part metal bumper of any of the above embodiments.

Within the scope of this application it is expressly intended that the various aspects, embodiments, examples and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present disclosure will now be described by way of example only, with reference to the accompanying drawings, in which:

FIG. 1 shows a perspective view of a vehicle according to an embodiment of the present disclosure;

FIG. 2A shows a perspective front view of a recessed roof panel according to an embodiment of the present disclosure;

FIG. 2B shows a perspective rear view of the recessed roof panel shown in FIG. 2A;

FIG. 3 shows a schematic front view of another embodiment of the recessed roof panel according to the present disclosure;

FIG. 4 shows a schematic front view of yet another embodiment of the recessed roof panel of the present disclosure;

FIG. 5 shows a perspective right-side view of a vehicle according to an embodiment of he present disclosure;

FIG. 6 shows a partial, perspective left-side view of the vehicle shown in FIG. 1;

FIG. 7A shows a top-view of an exemplary tie-down track;

FIG. 7B shows a side-view of the tie-down track of FIG. 7A;

FIG. 8 shows a plan view of an exemplary tie-down anchor;

FIG. 9 shows a partial, perspective left-side view of a vehicle according to an embodiment of the present disclosure.

FIG. 10 shows a door inner of the side doors shown in FIG. 6;

FIG. 11A shows an enlarged view of a first reinforcement structure;

FIG. 11B shows an enlarged view of alternative reinforcement structures;

FIG. 12 is a perspective front view of an embodiment of the vehicle of the present disclosure;

FIG. 13 is a perspective rear view of the vehicle shown in FIG. 12;

FIG. 14 is a perspective front view of an embodiment of the multi-part metal bumper, particularly a front bumper, of the present disclosure;

FIG. 15 is a perspective rear view of the multi-part metal bumper shown in FIG. 14;

FIG. 16 is an exploded view of the multi-part metal bumper shown in FIGS. 14 and 15;

FIG. 17 is an exploded view of an embodiment of the multi-part metal bumper, particularly a rear bumper, of the present disclosure; and

FIG. 18 is a perspective, assembled view of the multi-part metal bumper of FIG. 17 comprising a winch.

### DETAILED DESCRIPTION—RECESSED ROOF PANEL

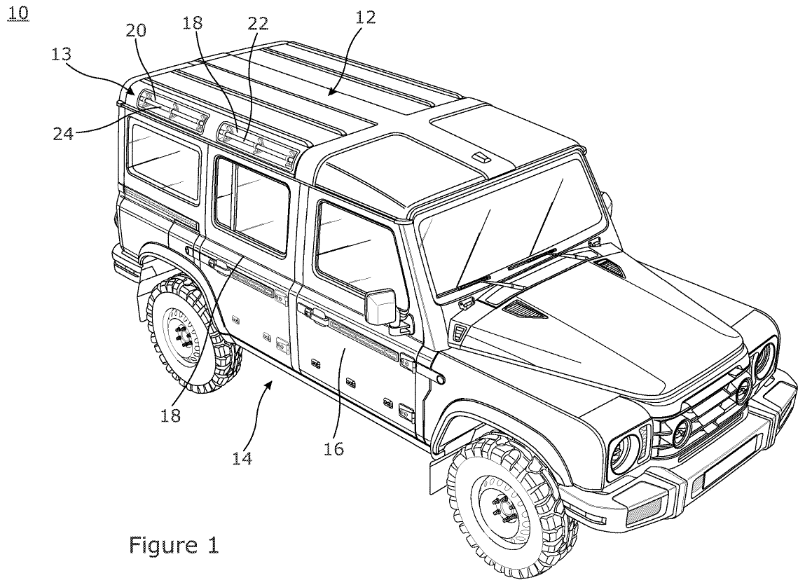

FIG. 1 shows a perspective view of a vehicle 10 according to an embodiment of the present disclosure. The vehicle 10 is an off-road vehicle and comprises a vehicle roof 12 as well as vehicle sides (only the right side shown) 14. The vehicle roof 12 has two side edges that connect the vehicle roof 12 to the sides (e.g. right side 14) of the vehicle 10. A right side edge 13 of the vehicle roof 12 connects the vehicle roof 12 to the right side 14 of the vehicle 10.

The right side edge 13 of the vehicle roof 12 in this embodiment is radiused to act as a transitioning portion between the generally horizontal vehicle roof 12 and the generally vertical vehicle side 14. The left side edge (not shown) of the roof 12 may be identical to the right side edge 13.

The vehicle side 14 in the embodiment of FIG. 1 has a front door 16 and a rear door 18. Of course, in some alternative variants, the vehicle may only have one or no side doors on the right vehicle side 14.

The vehicle 10 of FIG. 1 comprises two recessed roof panels. A first recessed roof panel 18 is arranged on the side edge 13 of the vehicle roof 12, above the rear door 18. A second recessed roof panel 20 is also arranged on the side edge 13 of the vehicle roof 12. The second recessed roof panel 20 is arranged behind the first recessed roof panel 18, i.e. between the first recessed roof panel 18 and a rear end of the vehicle 10. It will be understood that the vehicle 10 of FIG. 1 may also include front and rear recessed roof panels arranged on the other side edge of the vehicle roof 12, i.e. on a second edge of the vehicle roof 12 that is opposite to the first edge 13. In alternative embodiments (not shown) the vehicle may only comprise any other number of recessed roof panels arranged on the vehicle roof, particularly on one of the side edges of the vehicle roof 12.

The recessed roof panels 18, 20 are removably connected to the side edges 13 of the vehicle roof 12. As will be described in more detail below, the recessed roof panels 18, 20 comprise a housing that is received in a corresponding opening (e.g. a cut-out, not shown) of the vehicle frame along the side edge 13 of the vehicle roof 12. In other words, the recessed roof panels are removable from the frame of the vehicle 12. The recessed roof panels 18, 20 are, therefore, modular parts of the vehicle 12 that can easily be exchanged with different varieties of recessed roof panels or removed for maintenance purposes.

In the example of FIG. 1, the recessed roof panels 18, 20 house a tie-down system. In FIG. 1, the tie-down system includes a substantially vertical bar that can be used to attach straps, ropes, or any other fixation element to the vehicle. In one example, the bars 22, 24 of the first and second recessed roof panels 18, 20 may be used to strap objects to the vehicle roof 12 of the vehicle 10. The bars 18, 24 shown in FIG. 1 may also be stable enough to support the weight of one or more users, e.g. in order to climb onto the roof of the vehicle 10, when the vehicle 10 is stationary. It will be understood that the present disclosure is not limited to particular uses for the bars 22, 24 (i.e. the tie-down elements) of the recessed roof panels 18, 20, shown in FIG. 1.

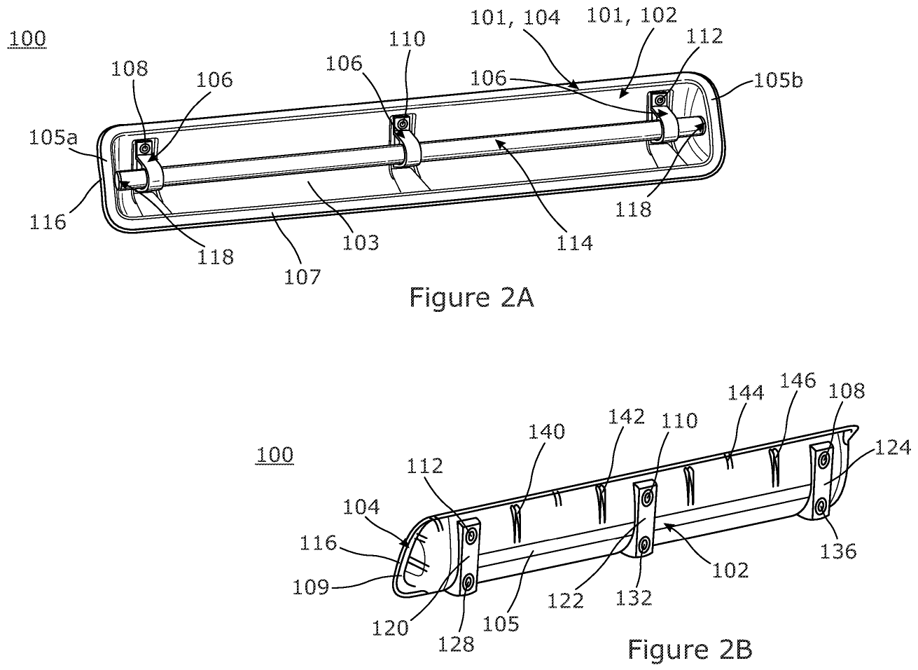

Turning to FIGS. 2A and 2B, there is shown a first embodiment of the recessed roof panel according to the present invention. The recessed roof panel 100 of the example shown in FIGS. 2A and 2B comprises a housing 101. The housing 101 comprises a basin 102 and a lip portion 104. The lip portion 104 surrounds the circumference of the basin 102.

The housing is preferably a single part structure, for example a moulded plastic part. The housing 101 is constructed from a material that is elastically deformable, e.g. plastic. In particular, the material of the housing 101 is more flexible than a frame of a vehicle the recessed roof panel is attached to. As will be explained in more detail below, this has the advantage that the housing 101, and particularly the lip portion 104 will stay in contact with the exterior surface of the vehicle, even if the vehicle frame deforms during operation.

The lip portion 104 extends around the circumference of the basin 102. The lip portion 104 has an internal surface 109 (FIG. 2B), which, when in use, faces an exterior surface of the vehicle frame. On an opposite site to the internal surface 109, the lip portion comprises an external surface 107, which, when in use, faces away from the vehicle frame.

In a vertical cross-section (not shown), the shape of the lip portion 104 along its side edges 105a, 105b is substantially identical to the shape of the side edge of the corresponding vehicle (e.g. side edge 13 in FIG. 1). In the example of FIG. 1, the side edges 105a, 105b of the lip portion 104 are radiused in the same manner as the vehicle roof side edge 13. Accordingly, the lip portion 104 conforms with the exterior surface of the vehicle frame (e.g. along the side edges of the roof).

The recessed roof panel 100 further comprises a sealing member 116. The sealing member 116 is arranged on the internal surface 109 of the lip portion 104. Consequently, when the recessed roof panel 100 is attached to the side edge of a vehicle roof, the sealing member 116 will be located between the internal surface of the lip portion 104 and an external surface of the vehicle frame. The sealing member 116 may be made of any waterproof elastomeric material, such as rubber.

The basin 102 has a concave surface 103 shown in FIG. 2A. A convex surface 105 (shown in FIG. 2B) is arranged on an opposite side of the basin 102. The concave surface 103 of the basin 102 is an external surface of the recessed roof panel 100. Similarly, the convex surface 105 is an internal surface of the recessed roof panel 100, when in use. The concave surface 103 may be constructed in such a way that water that enters the basin 102 from the vehicle roof, for example, will flow out of the basin 102 at its lower edge, when the recessed roof panel is arranged on the vehicle.

As shown in FIG. 2B, the convex (internal) surface 105 of the basin 102 comprises a plurality of reinforcement elements 140, 142, 144, 146. In the example of FIG. 2B, the reinforcement elements 140, 142, 144, 146 are reinforcement ribs extending from the lip portion 104 towards a central portion of the basin 102. The rib-shaped reinforcement elements 140, 142, 144, 146 shown in FIG. 2B increase in thickness towards the lip portion 104 of the housing 101.

The convex surface 105 of the basin 104 comprises a plurality of flange portions 120, 122, 124. In the example of FIG. 2, three flange portions 120, 122, 124 are arranged on the convex (internal) surface 105 of the basin 104. The flanged portions 120, 122, 124 are configured to abut against a part of the frame of the vehicle, when in use. The flange portions 120, 122, 124 are arranged on opposite sides of the basin 104 to connector the pieces 106 that will be described in more detail below.

The flanged portions 120, 122, 124 may be configured to abut against a reinforcement structure that is part of the vehicle frame. For example, the reinforcement structure may be arranged between an exterior surface and an interior surface of the vehicle roof. In other words, the reinforcement structure may be arranged inside a frame inner that is neither visible from the outside of the vehicle, nor from the inside, It follows that, in this example, the convex surface 105 together with the flanged portions 120, 122, 124 are then hidden inside the frame inner.

As mentioned above with reference to FIG. 1, the recessed roof panels 18, 20 are removably received within corresponding openings of the vehicle frame. In particular, the recessed roof panels 18, 20 are shaped and sized in such a way that the basin 102 will fit into the openings of the vehicle frame, whereas the lip portion 104 will substantially surround the openings. In other words, the lip portion 104 will abut against the exterior surface of the vehicle frame along the circumference of the frame opening.

Once the recessed roof panel is inserted into the opening, the lip portion 104 together with the sealing member 116 may be biased against the exterior surface of the vehicle frame. In one example, spring clips may be arranged between the vehicle frame and the internal surface 105 of the basin 102 in order to bias the lip portion 104 against the vehicle frame exterior. In this example, the spring clips will be received within an inner of the vehicle frame, together with the basin 102. The spring clips are preferably removably mounted such that the recessed roof panels are removable from the frame of the vehicle, e.g. for maintenance.

Going back to FIG. 2A, the recessed roof panel 100 of the embodiment shown in FIGS. 2A and 2B comprises three connector pieces 106. The connector pieces 106 are part of a tie-down system that may be used to attach items to the exterior surface of the vehicle, for example. Of course, it should be appreciated that the recessed roof panel 100 may have any number of connector pieces or, in some embodiments, no connector piece at all. The connector pieces 106 are preferably made of a shape stable material, such as metal. In particular, the connector pieces 106 are made of a material that is less deformable than the material of the housings 101. Accordingly, while the housing 101 is flexible to conform with the changing shape of the vehicle frame, during operation, the connector pieces 106 are configured to maintain their shape and provide a rigid anchor point on the exterior of the vehicle.

The connector pieces 106 are directly connected to the frame of the corresponding vehicle via a plurality of fastening elements 108, 110, 112, 128, 132, 136. The fastening members 108, 110, 112, 128, 132, 136 extend through the housing 101 of the recessed roof panel 100. In particular, the fastening members 108, 110, 112, 128, 132, 136 extend from the concave surface 103 of the basin 104 to the internal surface of the basin 104. As shown in FIG. 2B, the fastening elements extend through and protrude from the flanged portions 120, 122, 124. The fastening elements extend through the housing 101 and directly into the frame of the vehicle (not shown), The connector pieces 106 are, therefore, directly supported by the frame of the vehicle, rather than the flexible housing 101 of the roof panel. At the same time, the connector pieces act as additional removable connections between the roof panel 100 and the vehicle frame.

In the embodiment of FIGS. 2A and 2B, the connector pieces 106 are clamps adapted to receive a bar 114. The bar 114 extends through the clamps of the three connector pieces 106 and is, thus, connected to the vehicle frame via the connector pieces 106. The bar 114 extending between the connector pieces 106 may be a hollow metal bar, Accordingly, to prevent water from entering the hollow metal bar 114, the bar 114 may comprise end caps 118 for closing-off the open ends of the bar 114.

According to another aspect, neither the connector pieces 106 nor the bar 114 protrude from the cavity defined by the concave surface 103 of the basin 102, In other words, neither the connector pieces nor the bar 114 protrude over the lip portion 104 of the housing 101. Rather, the connector pieces 106 and the bar 114 are fully received within the cavity of the basin 102. Accordingly, no part of the recessed roof panel of the present disclosure protrudes over the exterior surface of the vehicle. This greatly reduces the chance of inadvertently getting stuck on the surrounding environment, such as trees and bushes the vehicle may be driving past.

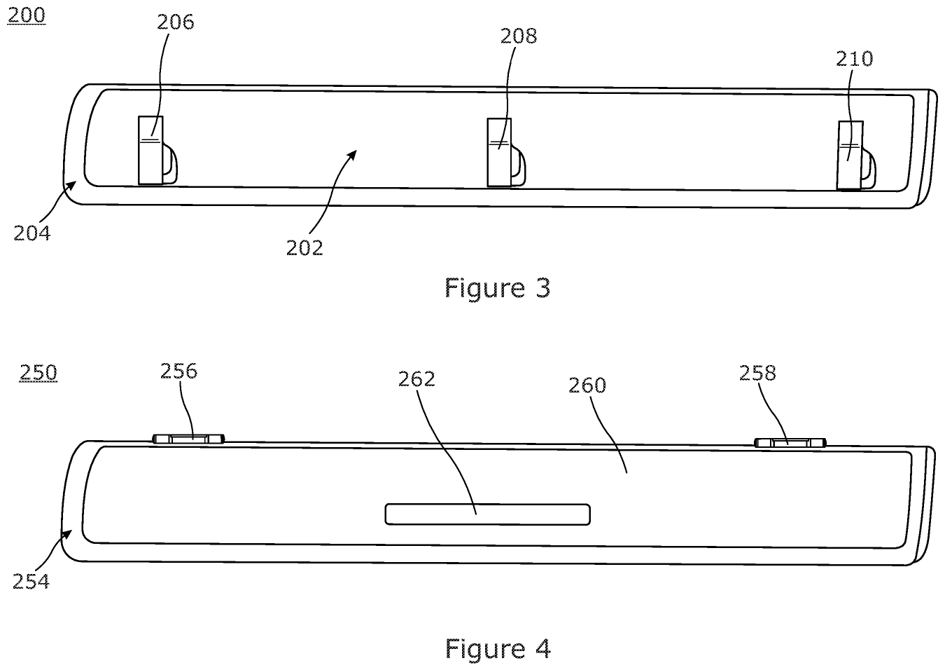

FIG. 3 shows a further embodiment of the recessed roof panel according to the present disclosure. The recessed roof panel 200 shown in FIG. 3 is substantially identical to the recessed roof panel 100 shown in FIGS. 2A, 2B, especially on its interior surface. The roof panel 200 of FIG. 3 comprises a basin 202 and a lip portion 204 surrounding the circumference of the basin 202.

In contrast to the recessed roof panel 100, the recessed roof panel 200 of FIG. 3 does not include a bar extending between the connector pieces. Rather, the recessed roof panel 200 of FIG. 3 includes three connector pieces 206, 208, 210, which may be clamps, studs, or lugs that can be used as part of a tie-down system for attaching straps or other accessories directly to the connector pieces 206, 208, 210. As mentioned above, the number of connector pieces is, of course, not limited to three.

An embodiment of the recessed roof panel according to the present disclosure that may not include any connector pieces is shown in FIG. 4, for example. The housing of the recessed roof panel 250 shown in FIG. 4 may be largely identical to the housing structure described with reference to the embodiment of FIGS. 2A and 2B. In particular, the recessed roof panel 250 of FIG. 4 may have a basin that is surrounded by a lip portion 254. The interior surface of the housing may be identical to the interior surface shown in FIG. 2B. However, the exterior surface, i.e. the concave surface of the basin (not shown) may not include connector pieces at all. Rather, the fastening elements 108, 110, 112, 128, 132, 136 shown in FIGS. 2A and 2B may be used for the sole purpose of attaching the housing to the vehicle frame, without also fixating connector pieces.

In view of the above, the recessed roof panel 250 of FIG. 4 may have a substantially empty cavity defined by the concave surface of the basin. This cavity may be used as an additional storage compartment of the vehicle. In the example of FIG. 4, a cover 260 may be provided that closes the cavity defined for protecting the cavity of the basin from the outside environment, e.g. rain or dust. The cover 260 may be pivotably connected to the housing, e.g. to the lip portion 304 of the housing, via one or more hinges 256, 258. In order to help operators open and close the cover 260, an optional handle 262 may be provided on the cover 260.

It should be understood that the cover 260 will have a radiused cross-section that conforms with the radiused shape of the side edge of the vehicle roof (e.g. roof side edge 13 of FIG. 1).

### DETAILED DESCRIPTION—TIE DOWN SYSTEM

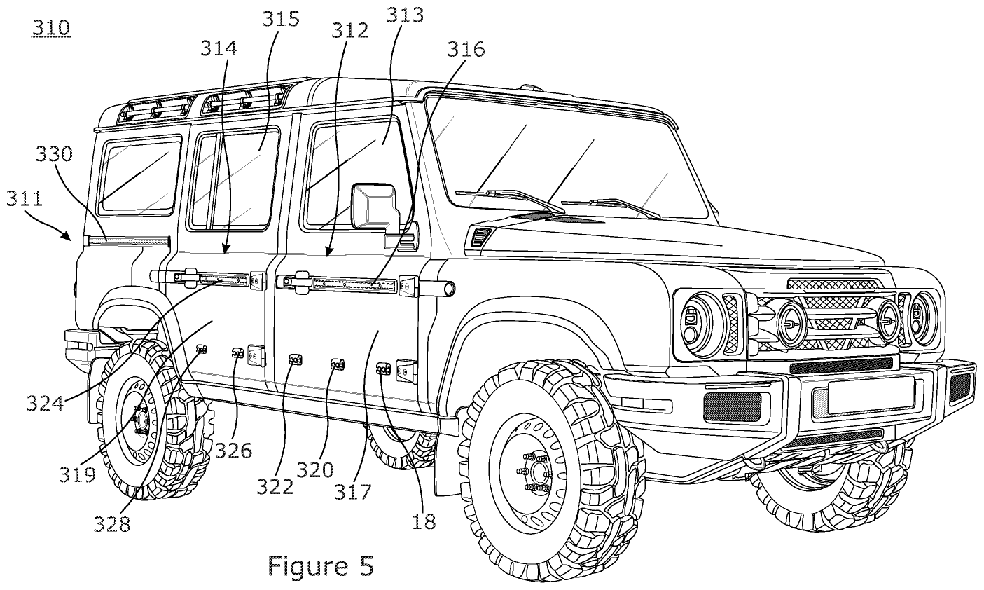

FIG. 5 shows a perspective front view of a vehicle according to an embodiment of the present disclosure. In particular, FIG. 5 is a front-right view of the vehicle 310. The vehicle 310 shown in FIG. 5 is an off-road vehicle.

In the illustration of FIG. 5, the right side 311 of the vehicle is shown in some detail. The right side 311 of the vehicle 310 comprises a front door 312 and a rear door 314. Both of the doors 312, 314 may include a window. In particular, the front door 312 may include a first window 313. The rear door 314 may include a second window 315. The operator may selectively open and close the windows 313, 315 in which case the windows 313, 315 will be retracted into a door inner of the front or rear doors 312, 314 respectively.

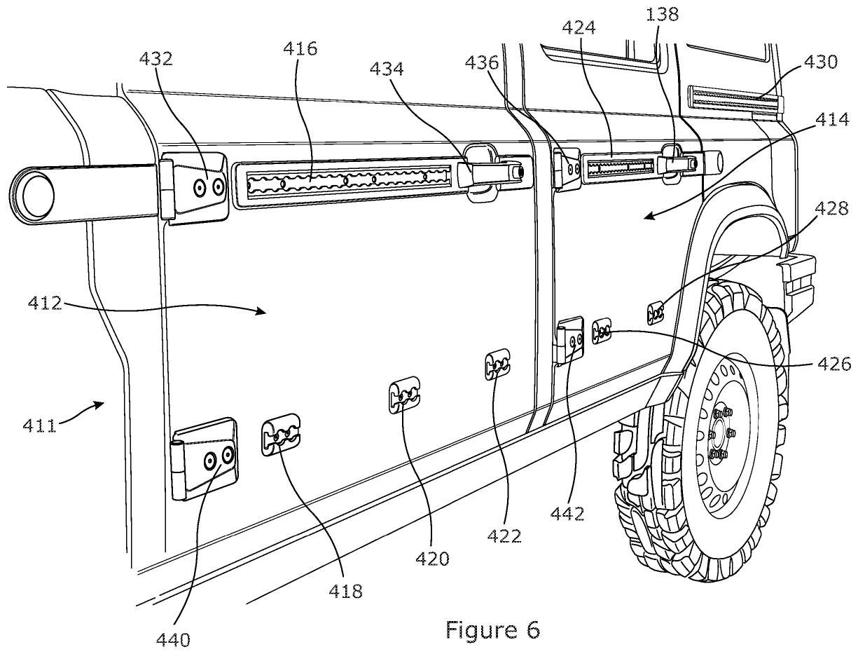

The vehicle 310 of FIG. 5 comprises a tie-down system arranged on the right side 311 of the vehicle and a tie-down system arranged on the left side (411, see FIG. 6) of the vehicle. It will be appreciated that tie-down systems could similarly be located on the front and/or the rear of the vehicle 310 (not shown). The tie-down system of the vehicle 310 is configured for removably securing items to the vehicle 310, and shall be explained in more detail below.

The tie-down system may include a variety of tie-down members. In the embodiment shown in FIG. 5, for example, four tie-down members are arranged on an external surface 317 of the front door 312. In particular, the front door 312 may include a first tie-down member in the form of a tie-down track 16, Three further tie-down members, such as the single mounts 318, 320, 322 may be connected to the exterior surface 317 of the front door 312. The three single mounts 318, 320, 322 are preferably arranged below the elongated tie-down track 316. The three single mounts 318, 320, 322 may be aligned horizontally with each other.

It should be appreciated that, in some examples, the elongated tie-down track 316 may be replaced by one or more single mounts. Similarly, the three single mounts 318, 320, 322 may be replaced by an elongated track. Alternatively, the number of single mounts may be changed.

Three tie-down members are arranged on an external surface 319 of the rear door 314. In particular, the rear door 314 may include a first tie-down member in the form of a tie-down track 324. Two further tie-down members, such as the single mounts 326, 328 are connected to the exterior surface 319 of the rear door 314. The two single mounts 326, 328 are preferably arranged below the elongated tie-down track 324. The two single mounts 326, 328 may be aligned horizontally with each other.

It should be appreciated that, in some examples, the elongated tie-down track 324 may be replaced by one or more single mounts. Similarly, the two single mounts 326, 328 may be replaced by an elongated track. Alternatively, the number of single mounts may be changed.

A third elongated tie-down track 330 is arranged at a rear end of the right side 311 of the vehicle 310. As is derivable from FIG. 5, the third elongated track 30 may be located higher than the first and second elongated tracks 316, 324 discussed above.

Turning to FIG. 6, there is shown a partial view of a left side of the vehicle 310. Parts of the left side 411 of the vehicle 310 that are substantially identical in function to parts of the right side 311 of vehicle 310 shown in FIG. 5 are represented with corresponding reference numbers increased by “100”. The left side 144 of the vehicle 310 comprises a front door 412 and a rear door 414. Similar to the right side 311 shown in FIG. 5, the left side 411 of FIG. 6 comprises a tie-down system with a plurality of tie-down members. In particular, the front door 412 of the vehicle 310 shown in FIG. 6 includes an elongated tie-down track 416 and three single mounts 418, 420, 422. The rear door 414 of the vehicle 310 comprises an elongated tie-down track 424 and two single mounts 426, 428. Similar to the tie-down system shown in FIG. 5, the single mounts 418, 420, 422, 426, 428 are arranged below their respective elongated tie-down tracks 416, 424.

The tie-down system of the embodiment shown in FIG. 6 also includes a third elongated tie-down track 430. The third elongated tie-down track 430 is arranged above the first and second elongated tie-down tracks 416, 424.

FIG. 6 further shows that the first elongated tie-down track 416 is arranged between a front door hinge 432, particularly an upper front door hinge 432, and a front door handle 434. In other words, the first elongated track 416 is horizontally aligned with the upper front door hinge 432 and the front door handle 434. This is particularly advantageous for stability reasons, since the hinge 432 and the door handle 434 represent reinforced parts of the front door 412. Objects connected to the first elongated tie-down track 416, therefore, benefit from additional stability provided by the door hinge 432 and the door handle 434. This also means that higher loads may be attached to the first elongated tie-down track 416.

The second elongated tie-down track 424 of the rear door 414 may be arranged between an upper rear door hinge 436 of the rear door 414 and a rear door handle 438 of the rear door 414. In other words, the second elongated tie-down track 424 may be horizontally aligned with the upper front door hinge 436 and the rear door handle 438 of the rear door 414.

The first elongated tie-down track 416 may be horizontally aligned with the second elongated tie-down track 424.

The single mounts 418, 420, 422 may be horizontally aligned with a lower front door hinge 440 of the front door 412. The single mounts 426, 428 of the rear door 414 may be horizontally with a lower rear door hinge 442 of the rear door 412. The single mounts 418, 420, 422 of the front door 412 may be horizontally aligned with the single mount 426, 428 of the rear door 414.

As mentioned above, the horizontal alignment of the tie-down members (e.g. the tie-down tracks and the single mounts) with the door hinges 432, 436, 440, 442 and the door handles 434, 438 has stability advantages. Of course, this effect is not dependent on the particular size and shape of the tie-down members. Rather, the single mounts 418, 420, 422, 426, 428 may also be replaced by elongated tie-down tracks. Similarly, the elongated tie-down tracks 416, 424 may be replaced by one more or single mounts or various other suitable tie-down members.

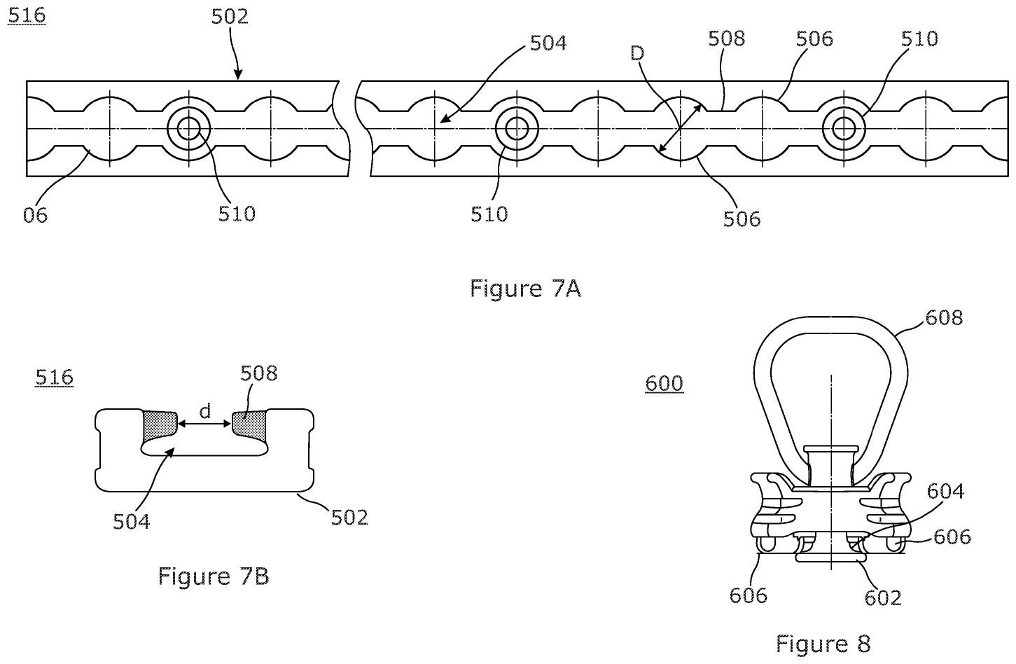

Turning to FIG. 7A, there is shown a top-plan view of one example of an elongated tie-down track 516, such as the elongated tie-down tracks 316, 324, 330, 416, 424, 130 shown in FIGS. 5 and 6. FIG. 7B shows a side view of the elongated tie-down track 516 shown in FIG. 7A.

The elongated tie-down track 516 shown in FIGS. 7A and 7B comprises an elongated tie-down base 502. The elongated tie-down base 502 comprises a longitudinal guide groove 504. The longitudinal guide groove 504 is adapted to moveably receive a corresponding tie-down anchor, as will be described in more detail with reference to FIG. 8 below.

The longitudinal guide groove 504 comprises a plurality of insert openings 506. The insert openings 506 are adapted for inserting the tie-down anchors into the elongated tie-down base 502, particularly into the guide groove 504 of the tie-down track 516. Adjacent insert openings 506 are connected by slotted sections 508. The slotted sections 508 of the track 516 shown in FIGS. 7A and 7B are straight slots with a width d that is smaller than a width or diameter D of the insert openings 506. In particular, the slot width d of the slotted sections 508 that connect adjacent insert openings is smaller than a diameter D of the insert openings 506.

Outer edges of the insert openings 506 and the slotted sections 508 may be rounded off. In other words, the edges of the insert openings 506 and the slotted sections 508 that face away from the vehicle may be radiused so as to avoid sharp outside edges along the exterior of the vehicle. Such radiused edges effectively help to lower the risk of injury when passing the vehicle. It also reduces the chance of getting clothes caught on the edges of the elongated tie down track.

Although the insert openings 506 are shown as having a circular shape, it will be understood that the insert openings 506 may have any other suitable shape for inserting the tie-down anchor, such as a diamond shape or a rectangular shape.

The elongated tie-down base 502 comprises a plurality of fastening openings 510. As will be explained in more detail below, the fastening openings 510 may be used to removably attach the elongated tie-down track 516 to the exterior of the vehicle, e.g. to an exterior surface (317, 319) of the vehicle door (312, 314) such as shown in FIGS. 5 and 6. To this end, fastening members, such as threaded bolts may be introduced into the fastening openings 510 of the track 516.

Turning to FIG. 8 there is shown an example of a suitable tie-down anchor. The tie-down anchor 600 shown in FIG. 8 is configured to be inserted into the elongated tie-down track 516 shown in FIGS. 7A and 7B. As mentioned briefly above, the tie-down anchor 600 may be inserted into the elongated tie-down track 516 via one of the insert openings 506. In particular, the tie-down anchor comprises a slidable guide pin 602 arranged at a lower end of the tie-down anchor 600. The guide pin 602 has a shape that corresponds with the shape of the insert openings 506 of the track 516. In this example, the lower portion of the guide pin 602 has a circular shape that has a diameter slightly lower than the diameter D of the insert openings 506. The guide pin 602 also includes a cylindrical neck portion 604 with a reduced diameter. The diameter of the neck portion 604 is smaller than the width d of the slotted sections 508. Accordingly, once the guide pin 602 is inserted into the elongated tie-down track 516, the tie-down anchor 600 may slide along the longitudinal guide groove 504 of the track 516 freely until a locking member 606 of the anchor 600 is engaged.

The tie-down anchor 600 comprises two locking members 606 arranged next to the guide pin 602. When the hook 602 is positioned along the longitudinal guide groove 504 in alignment with a slotted section 508, the locking member 606 may be engaged to prevent the anchor 600 from further longitudinal movement along the groove 504. To this end, the locking member 606 may be adapted to engage with the insert openings 506 in a manner that prevents longitudinal movement of the anchor in either direction along the longitudinal groove 504.

In view of the above, the tie-down anchor 600 may be locked in position at any slotted section 508 along the tie-down base 502. In other words, the tie-down anchor 600 may be arranged at various positions along the longitudinal axis of the elongated tie-down track 516.

The tie-down anchor 600 of the example shown in FIG. 8 comprises a lashing hook 608 that is connected to the guide pin 602. The lashing hook 608 may be used to secure a variety of tie-down accessories, such as tie-down straps or nets. It will be understood that the tie-down anchor 600 may also comprise alternative means for attachment, e.g. studs rather than hooks.

The singles mounts 318, 320, 322, 326, 328, 418, 420, 422, 426, 428 shown in FIGS. 5 and 6, for example, may have a similar structure to the elongated tie-down track 516 shown in FIGS. 7A and 7B. In particular, the single mounts shown in FIGS. 5 and 6 may also include insert openings that are connected by slotted sections. However, in contrast to the elongated tie-down tracks, the single mounts may only comprise two insert-openings that are connected by a single slotted section. It will be appreciated from the above explanation of the tie-down anchor 600 in FIG. 8 that this layout of the single mounts may allow the anchor to be inserted into either of the two insert-openings. Yet, the anchor 600 may then only be fixed in place in one position, i.e. in alignment with the single slotted section of the single mounts.

Similar to the outer edges of the insert-openings 506 and the slotted sections 508 of the elongated tie-down track, the edges of the two insert-openings and the single slotted section of the single mounts 318, 320, 322, 326, 328, 418, 420, 422, 426, 428 may also be rounded off. In other words, the edges of the insert openings and the slotted sections that face away from the vehicle may be radiused so as to avoid sharp outside edges along the exterior of the vehicle.

In one example, if tie-down anchors, such as the tie-down anchor 600 shown in FIG. 8, are inserted into all of the tie-down members of the front door 412 shown in FIG. 6, for example, straps may be attached to the various anchors in order to tie an object to the front door 412. Of course, the same applies to the other tie-down members explained with reference FIGS. 5 and 6.

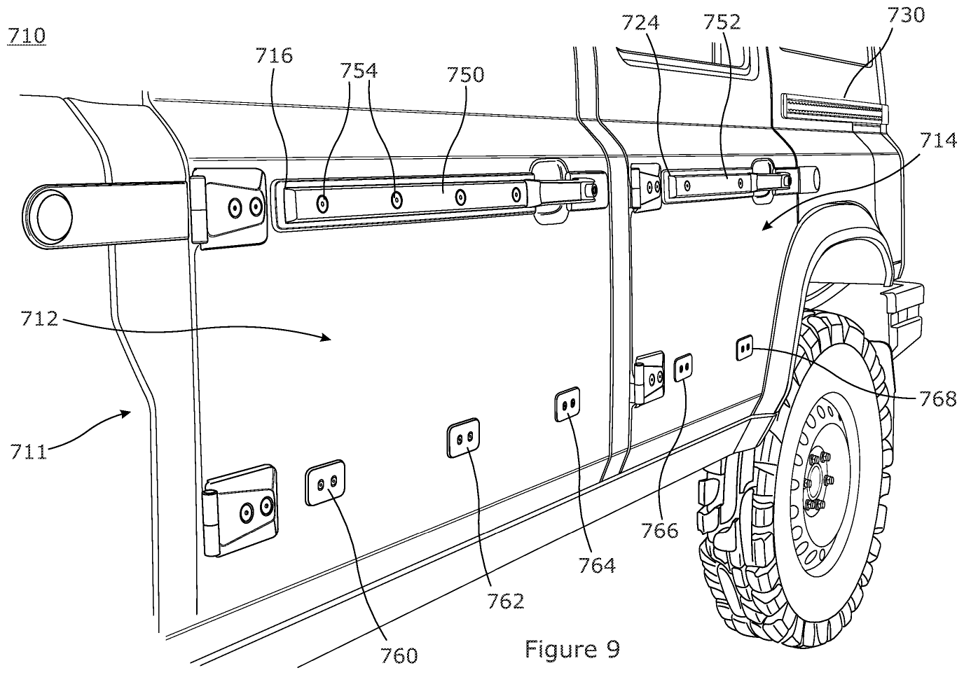

Turning to FIG. 9, there is shown a perspective left side view of a vehicle according to another embodiment of the present disclosure. The side 711 of the vehicle 710 shown in FIG. 9 comprises three tie-down tracks. In particular, the tie-down system of FIG. 9 includes a first tie-down track 716 arranged on an exterior surface of a front door 712. A second elongated tie-down track 724 is arranged on an exterior surface of a rear door 714. A third elongated tie-down track 730 is arranged on an exterior surface of a rear end of the side 711.

The elongated tie-down tracks 716, 720, 730 are generally identical to the tie-down tracks 316, 324, 330 of FIG. 6. However, in addition to the embodiment shown in FIG. 6, the vehicle 710 of FIG. 9 further includes a first track cover 750 attached to the first elongated tie-down track 716 and a second track cover 752 attached to the second tie-down track 724. The track covers 750, 752 are configured to cover the insert openings and the slotted sections of the elongated tracks 716, 724. Accordingly, the track covers 750, 752 may be used to shield the guide groove of the elongated tie-down tracks from the outside environment when the elongated tie-down tracks are not in use. At the same time, the track covers 750, 752 prevent injury of individuals walking past the side 711 of the vehicle 710, e.g. when getting clothes caught on the slotted sections of the tie-down tracks.

The track covers 750, 752 may be attached to the elongated tie-down tracks 716, 724 via fastening members 754 that extend through the fastening openings of the tracks, such as the fastening openings 510 shown in FIG. 7A. As will be described in more detail below, the fastening members 754 may then extend through the fastening openings of the track into a door inner and be fastened against a reinforcement structure located within the door inner.

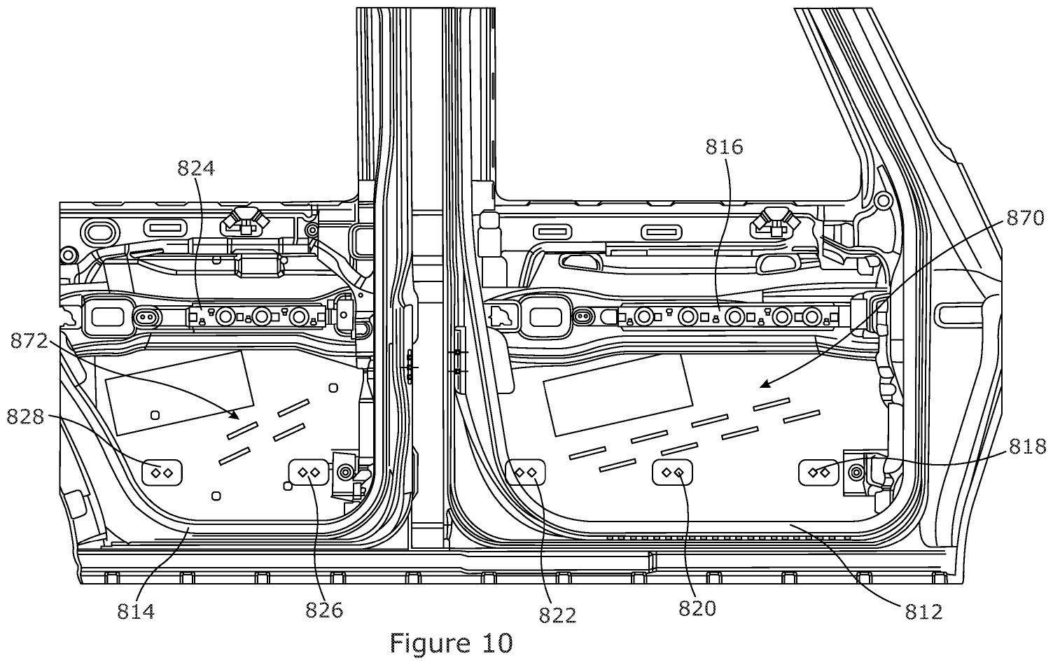

In the embodiment of FIG. 9, no single mounts are attached to the front or rear doors 712, 714. Instead, mounting hole covers 760, 762, 764, 766, 768 are provided on the front and rear doors 712, 714. The mounting hole covers each may have two fastening members attaching the mounting hole covers 760, 762, 764, 766, 768 to a reinforcement structure arranged within the door inner, as will be described with reference to FIG. 10. Each of the mounting hole covers 760, 762, 764, 766, 768 can be easily replaced by a single mount, such as the single mounts 418, 420, 422, 426, 428 shown in FIG. 6.

FIG. 10 shows door cavities of the front and rear doors of an embodiment of a vehicle according to the present disclosure. The front door 812 of FIG. 10 has a front door cavity 870. The front door cavity 870 extends between an exterior surface of the front door 812, i.e. an external surface of the vehicle, and an interior surface of the front door 812, e.g. a trim panel visible inside the vehicle.

The rear door 814 of FIG. 10 has a rear door cavity 872. The rear door cavity 872 extends between an exterior surface of the rear door 814, i.e. an exterior surface of the vehicle, and an interior surface of the rear door 814, e.g. a trim panel visible inside the vehicle.

A front door reinforcement structure is arranged in the front door cavity 870. The front door reinforcement structure is configured for removably connecting the tie-down members of the front door (e.g. the track 416, and the single mounts 418, 420, 422 of FIG. 6), to the vehicle. To this end, the fastening elements, e.g. the fastening bolts described with reference to the elongated tie-down track in FIG. 7A, may be received in corresponding parts of the front door reinforcement structure.

In the embodiment of FIG. 10, the front door reinforcement structure comprises a plurality of reinforcement plates 816, 818, 820, 822. A first reinforcement plate 816 is an elongated plate extending between an upper door hinge and a door handle of the front door 812.

The first reinforcement plate 816 is aligned with the first elongated track 416 (FIG. 6) and arranged on an opposite side of the front door exterior surface (17, FIG. 6). Second, third and fourth reinforcement plates 818, 820, 822 are arranged below the first reinforcement plate 816 within the front door cavity 870. The second reinforcement plate 818 is aligned with the first single mount 418. The third reinforcement plate 820 is aligned with the second single mount 420. The fourth reinforcement plate 822 is aligned with the third single mount 422.

The rear door reinforcement structure comprises a plurality of reinforcement plates 824, 826. 828. A first reinforcement plate 824 is an elongated plate extending between an upper door hinge and a door handle of the rear door 814.

The first reinforcement plate 824 of the rear door 814 is aligned with the second elongated track 424 (FIG. 6) and arranged on an opposite side of the rear door exterior surface (319, FIG. 5). Second and third reinforcement plates 826, 828 are arranged below the first reinforcement plate 824 within the rear door cavity 872. The second reinforcement plate 826 is aligned with the first single mount 426 of the rear door 414. The third reinforcement plate 828 is aligned with the second single mount 428 of the rear door 414.

The reinforcement plates may be constructed to be more rigid than an external wall of the vehicle doors that defines the exterior surface of the doors. In other words, the reinforcement plates are more resistant to plastic deformation than the outer walls of the vehicle doors.

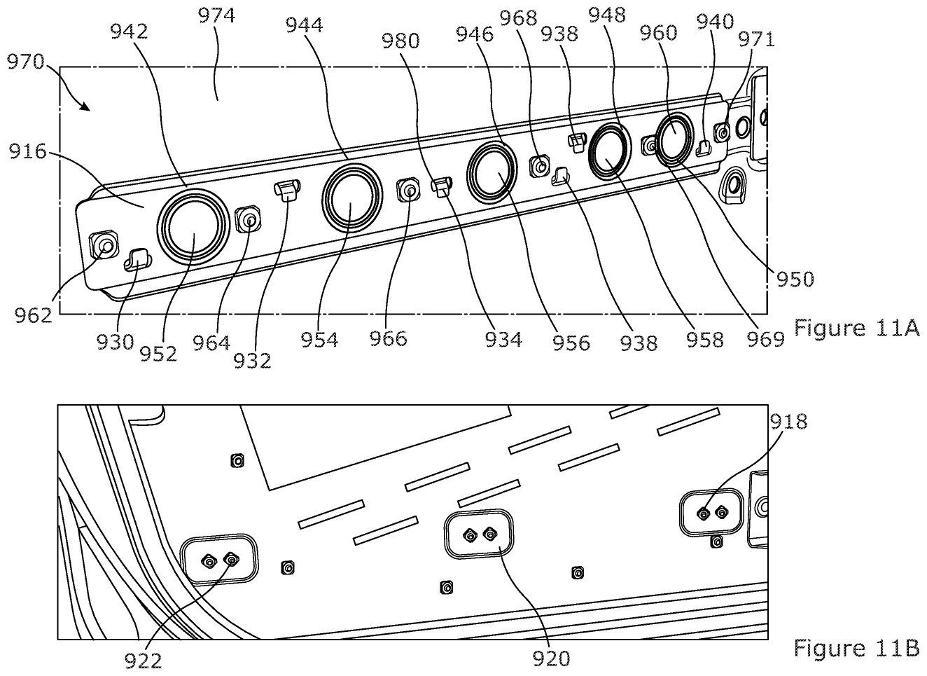

FIGS. 11A and 11B show enlarged views of reinforcement plates 916, 918, 920, 922. The reinforcement plate 916, 918, 920, 922 shown in FIGS. 11A and 11B may be identical to the reinforcement plates shown in FIG. 10.

An elongated reinforcement plate 916 is shown in FIG. 11A. The elongated reinforcement plate 916 is removably connected to an interior wall 974 of a door cavity 970. In more detail, the elongated reinforcement plate 916 may be connected to the interior wall 974 of the door cavity 970 via one or more pins 930, 932, 934, 936, 938, 940 protruding from the interior wall 974 of the front door cavity 970. The pins are bendable and initially extend perpendicularly from the interior wall 974 into the door cavity 970. The elongated reinforcement plate 916 is then put over the pins 930, 932, 934, 936, 938, 940 via corresponding slots (e.g. slot 980) of the reinforcement plate 916. Once the pins 930, 932, 934, 936, 938, 940 extend through the corresponding slots of the reinforcement plate 916, the pins 930, 932, 934, 936, 938, 940 may be bent upwards or downwards as represented in FIG. 11A to initially secure the reinforcement plate 916 against the interior wall 974 of the front door.

In order to obtain reliable alignment between the reinforcement plate 916 and the tie-down track on the exterior surface of the vehicle, the reinforcement plate 916 may further comprise a plurality of alignment means. In the example of FIG. 11A, the alignment means comprise (circular) openings 942, 944, 946, 948, 950. The openings 942 to 950 are adapted to receive corresponding protrusions 952, 954, 956, 958, 960. The protrusions 952, 954, 956, 958, 960 shown in FIG. 11A protrude from the interior wall 974 of the door cavity 970. The protrusions 952, 954, 956, 958, 960 and the corresponding openings 942, 944, 946, 948, 950 are sized with small tolerances, such that putting the openings 942, 944, 946, 948, 950 over the protrusions 952, 954, 956, 958, 960 will result in exact alignment of the reinforcement plate 916 with the tie-down track (e.g. 416, FIG. 6) in a horizontal and a vertical direction.

A plurality of fastening members 962, 964, 966, 968, 969, 971 connecting the corresponding elongated tie-down track (e.g. 416 of FIG. 6) to the exterior of the vehicle extend through corresponding openings (not shown) within the reinforcement plate 916. Alignment of the fastening members 962, 964, 966, 968, 969, 971 with the openings of the reinforcement plate 916 is established via the alignment means discussed above. The fastening members 962 to 971 may be fixed against the reinforcement plate 916 via corresponding nuts as represented in FIG. 11A.

Turning to FIG. 11B, there are shown three reinforcement plates 918, 920, 922. The three reinforcement plates 918 to 922 are aligned with the single mounts on the exterior surface of the vehicle (e.g. single mounts 418, 420, 422 of FIG. 6). Each of the reinforcement plates 918, 920, 922 of FIG. 11B receives two fastening members of the corresponding single mount that is arranged on the exterior surface of the vehicle. Similar to the illustration of FIG. 11A, the fastening members of FIG. 11B may extend through corresponding openings of the reinforcement plates 918 to 922 and may be secured against the reinforcement plates 918 to 922 via nuts.

### DETAILED DESCRIPTION—MULTI-PART BUMPER

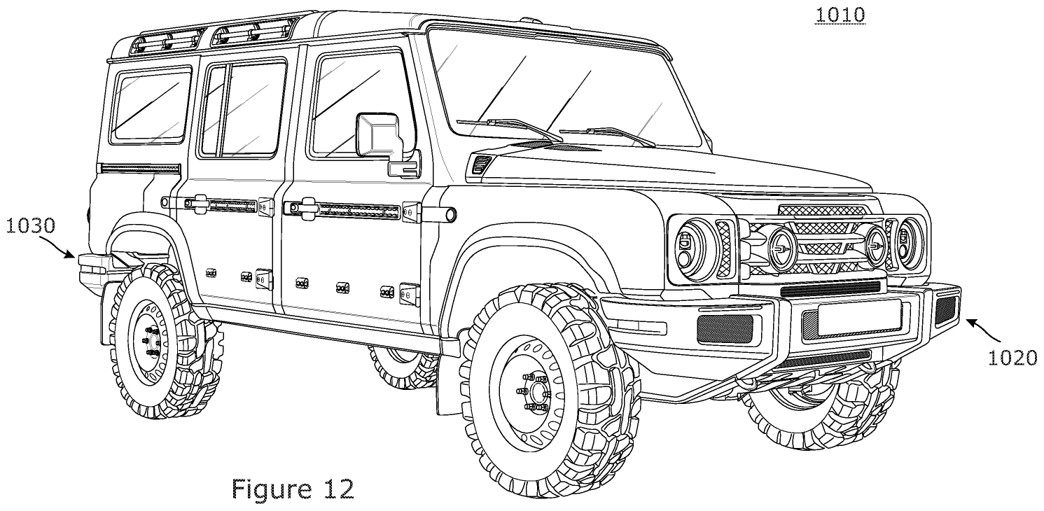

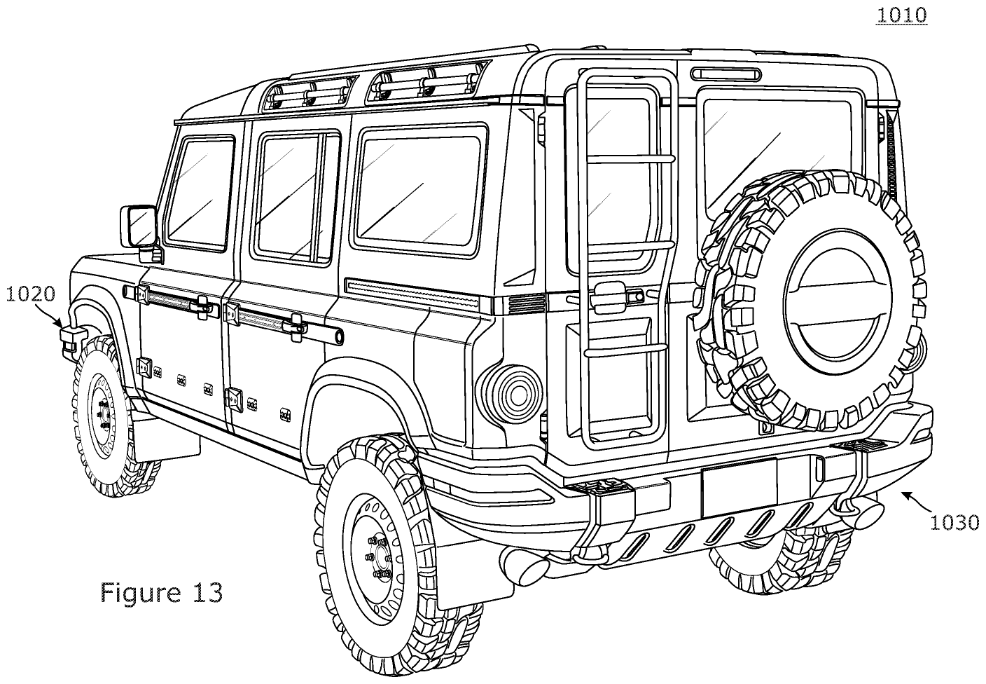

FIGS. 12 and 13 show perspective views of a vehicle 1010, particularly an off-road vehicle. The vehicle 1010 comprises a multi-part metal bumper 1020 located at its front. The vehicle 1010 comprises a multi-part metal bumper 1030 located at its rear. The multi-part metal bumpers 1020, 1030 are removably connectable to the chassis of the vehicle 1010.

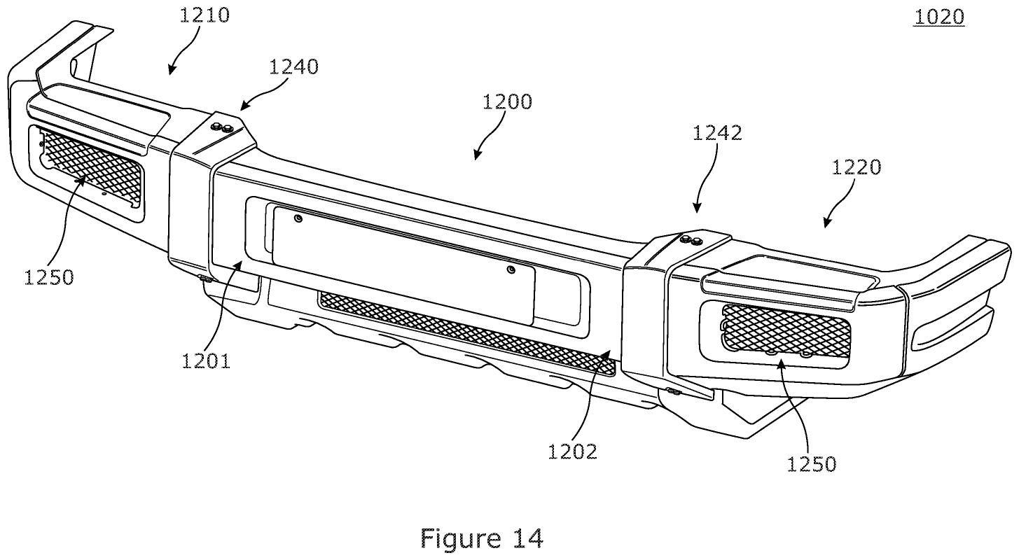

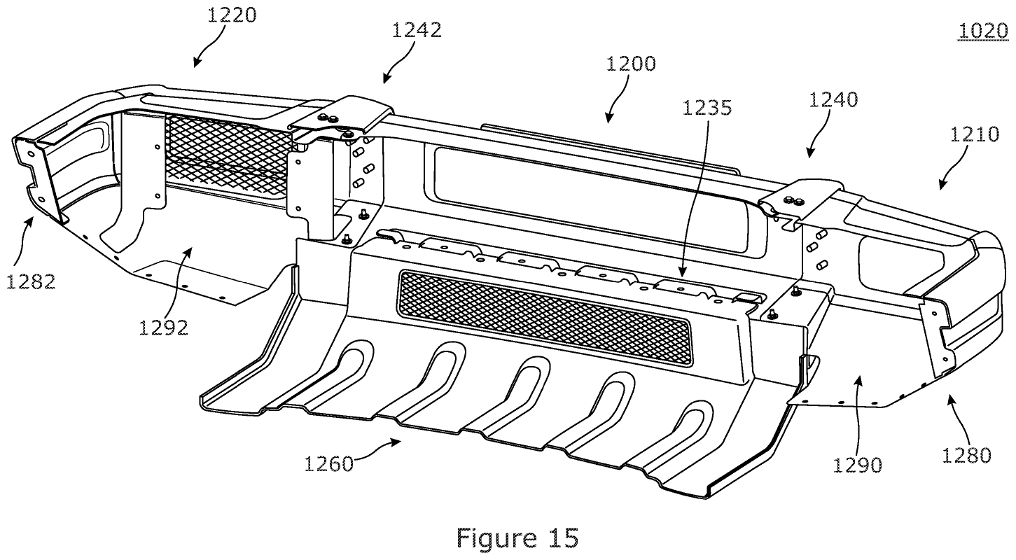

Turning to FIGS. 14 to 16, the multi-part metal bumper 1020 is shown to comprise a plurality of bumper segments. The plurality of bumper segments include a central bumper segment 1200, a first side bumper segment 1210, and a second side bumper segment 1220. The first side bumper segment 1210 comprises a first side bumper subsegment 1290. The second side bumper segment 1220 comprises a second side bumper subsegment 1292. The first and second side bumper subsegments 1290, 1292 are removably connectable to the first and second side bumper segments 1210, 1220.

In other embodiments, the multi-part metal bumper may comprise only two bumper segments or more than three bumper segments. The plurality of bumper segments may comprise additional bumper segments that are removably connectable to any of the central bumper segment, the first side bumper segment and the second side bumper segment. Alternatively or additionally, only one of the plurality of bumper segments or each one of the plurality of bumper segments may comprise a bumper subsegment, i.e. a component connectable to a bumper segment to complement it aesthetically or functionally. Bumper subsegments may be removably connectable to the bumper segments laterally or vertically to allow for easy replacement. For example, bumper subsegments may be advantageously replaced with a thicker and more durable bumper subsegment. The bumper subsegments may alternatively be fixed to the bumper segments.

The bumper segments 1200, 1210, 1220 are reinforced by reinforcement elements 1280, 1282. In the embodiment of FIGS. 14 to 16, the first side bumper segment 1210 is reinforced with a first reinforcement element 1280. The second bumper segment 1220 is reinforced with a second reinforcement element 1282. The bumper segments 1200, 1210, 1220 may be reinforced by any number of reinforcement elements.

The plurality of bumper segments 1200, 1210, 1220 shown in FIGS. 14 to 16 have a substantially C-shaped cross-section. The C-shaped cross-section of the bumper segments 1200, 1210, 1220 is formed by the bumper segments 1200, 1210, 1220 each having a top portion, a middle portion, and a bottom portion. In use, the top portion of the bumper segments 1200, 1210, 1220 is substantially horizontal. The middle portion of the bumper segments 1200, 1210, 1220 is substantially vertical and substantially at a 90 degree angle with respect to the top portion of the bumper segments 1200, 1210, 1220. The bottom portion of the bumper segments 1200, 1210, 1220 is angled at an obtuse angle with respect to the middle portion of the bumper segments 1200, 1210, 1220. The top portion, middle portion and bottom portion of the bumper segments 1200, 1210, 1220 are shaped to enable the multi-part metal bumper to removably connect to the chassis of the vehicle. The first and second side segments 1210, 1220 comprise a first and second side subsegments 1290, 1292 that are removably connectable to the bottom portion of their respective first or second side segments 1210, 1220. The first side subsegment 1290 is removably connectable to a bottom portion of the first side bumper segments 1210. The second side subsegment 1292 is removably connectable to a bottom portion of the second side bumper segments 1220.

The reinforcement segments 1280, 1282 may be configured to extend between the top and bottom portion of the C-shaped bumper segments 1200, 1210, 1220.

The central bumper segment 1200 is substantially straight along its longitudinal axis. Each of the first side segment and the second side segment 1210, 1220 is curved forming a 90 degree angle corner. The plurality of bumper segments 1200, 1210, 1220 are shaped to enable the multi-part metal bumper to removably connect to the vehicle. The first and second side subsegments 1290, 1292 each have a shape that matches angled bottom portions of the first and second side bumper segments. The first and second side subsegments 1290, 1292 each have a shape defining an angled surface that curves around a 90 degree angle. The angle of the angled surface varies along its height such that, at its point most distant from the bottom portions, the angled surface is substantially horizontal.

The plurality of bumper segments may be formed by portions other than a top portion, a middle portion and a bottom portion and/or the portions may be arranged at substantially different angles depending on the characteristics of the vehicle to which the multi-part metal bumper is removably connected.

In certain embodiments the bumper segments may be pressed metal pieces. The bumper segments may be made from plate metal, particularly steel plates.

The plurality of bumper segments 1200, 1210, 1220 comprises the central bumper segment 1200, the first side bumper segment 1210 and the second side bumper segment 1220. The first side bumper segment is adjacent to a first end 1201 of the central bumper segment 1200 and the second bumper segment 1220 is adjacent to a second end 1202 of the central bumper segment 1200, the first and second ends 1201, 1202 of the central bumper segment being arranged on opposite sides of the central bumper segment 1200.

It will be understood that, when assembled, the first side bumper segment 1210 is removably connected to a first end 1201 of the central bumper segment 1200. The second bumper segment 1220 is removably connected to a second end 1202 of the central bumper segment 1200 when the plurality of bumper segments 1200, 1210, 1220 are connected to each other.

The plurality of bumper segments 1200, 1210, 1220 are removably connected to each other via connector plates. The plurality of bumper segments comprise sets of connector plates 1205a, 1205b, 1215, 1225, each set of connector plates comprising a top, middle and bottom connector plate at the top, middle and bottom portion of each bumper segment respectively. Each of the top, middle and bottom connector plates of the sets of connector plates 1205a, 1205b, 1215, 1225 comprises at least one fastening hole. The fastening holes each receive a fastener element for removably connecting the connector plates to the chassis and/or each other.

The central bumper segment 1200 comprises a first set of connector plates 1205a extending from its first end 1201 and a second set of connector plates 1205b extending from its second end 1202. The first side bumper segment 1210 comprises a third set of connector plates 1215 extending from an end that is adjacent to the central bumper segment 1200 when the first side bumper segment 1210 and central bumper segment 1200 are connected to each other. The second side bumper segment 1200 comprises a fourth set of connector plates 1225 extending from an end that is adjacent to the central bumper segment 1200 when the second side bumper segment 1220 and central bumper segment 1200 are connected to each other. The sets of connector plates 1205a, 1205b, 1215, 1225 are an integral part of their corresponding bumper segments 1200, 1210, 1220.

The first and second side bumper segments 1210, 1220 comprise the third and fourth sets of connector plates 1215, 1225 respectively. Each set of connector plates 1215, 1225 comprise bottom connector plates at the bottom portion of the first and second side bumper segments 1210, 1220. In the embodiment shown, the bottom connector plates are arranged along side edges of the first and second side bumper subsegments 1290, 1292.

The first set of connector plates 1205a partially overlaps with the third set of connector plates 1215 such that two fastening holes on each of the top, middle and bottom connector plates of the first set of connector plates 1205a are aligned with two fastening holes on each of the top, middle and bottom connector plates of the third set of connector plates 1215. The aligned fastening holes of the overlapping top and middle connector plates of the first and third sets of connector plates 1205a, 1215 receive common fasteners for removably connecting the central bumper segment 1200 and the first side bumper segment 1210 to each other and to the chassis. The aligned fastening holes of the overlapping bottom connector plates of the first and third sets of connector plates 1205a, 1215 receive common fasteners for removably connecting the central bumper segment 1200 and the first side bumper segment 1210 to each other.

The second set of connector plates 1205b partially overlaps with the fourth set of connector plates 1225 such that the two fastening holes on each of the top, middle and bottom connector plates of the second set of connector plates 1205b are aligned with two fastening holes on each of the top, middle and bottom connector plates of the fourth set of connector plates 1225. The aligned fastening holes of the overlapping top and middle connector plates of the second and fourth sets of connector plates 1205b, 1225 receive common fasteners for removably connecting the central bumper segment 1200 and the second side bumper segment 1220 to each other and to the chassis. The aligned fastening holes of the overlapping bottom connector plates of the second and fourth sets of connector plates 1205b, 1225 receive common fasteners for removably connecting the central bumper segment 1200 and the second side bumper segment 1220 to each other.

The middle portions of the third and fourth sets of connector plates 1215, 1225 each comprise four fastening holes. Two of the fastening holes of each of the middle portions of the third and fourth sets of connector plates 1215, 1225 are aligned with the fastening holes of the middle portions of the first and second sets of connector plates 1205a, 1205b as described above. The other two fastening holes of each of the middle portions of the third and fourth sets of connector plates 1215, 1225 receive common fasteners for removably connecting the first and second side bumpers 1210, 1220 to the chassis.

The bottom portion of the central bumper segment 1200 comprises six longitudinal connector plates 1235 distributed along the length of the central bumper segment 1200 as shown in FIG. 15. The longitudinal connector plates 1235 extend from the inside surface of the bottom portion of the central bumper segment 1200 at an angle with respect to the surface of the bottom portion such that the longitudinal connector plates 1235 are substantially parallel with the top portion of the central bumper segment 1200. Four of the longitudinal connector plates comprise fastening holes for receiving a common fastener for removably connecting the central bumper segment 1200 to the chassis.

The first and second side bumper segments 1210, 1220 each comprise a first and a second pair of connector brackets 1230, 1232 respectively. The first and second pairs of connector brackets 1230, 1232 are mounted on the top and bottom connector plates of the third and fourth sets of connector plates 1215, 1225. Each connector bracket of the first and second pairs of connector brackets 1230, 1232 comprises two fastening holes.

The multi-part metal bumper 1020 comprises two cover elements 1240, 1242 for covering the connector plates 1205a, 1205b, 1215, 1225. The cover elements 1240, 1242 have a substantially C-shaped cross-section, defining a top, and bottom portion at its ends. The cover elements 1240, 1242 shown in FIGS. 14 to 16 may be configured as bull bars. Each of the cover elements 1240, 1242 comprises two fastening holes at each of top and bottom portions.

When assembled, the fastening holes of the cover elements 1240, 1242 are aligned with the fastening holes of the first and second pair of connector brackets 1230, 1232 to receive common fasteners for removably connecting each of the cover elements 1240, 1242 to the first and second pair of connector brackets 1230, 1232 and consequently to the third and fourth connector plates 1225.

It will be understood that features such as the number of fastening holes or number of longitudinal connector plates may vary in other embodiments.

In some embodiments, the first and second side bumper segments may not comprise connector brackets, Instead, the fastening holes of the cover elements may be aligned with the fastening holes of the connector plates to receive common fasteners for removably connecting the cover elements to the connector plates and the chassis.

In other embodiments, the connector plates may not overlap. Each of the first, second, third and fourth sets of connector plates may be removably connected to each other via the chassis. The cover elements may at least partially cover two adjacent connector plates. The cover elements may have at least one fastening hole for receiving a common fastener for removably connecting the cover element to a first connector plate and at least one other fastening hole for receiving a common fastener for removably connecting the cover element to a second connector plate.

The plurality of bumper segments 1200, 1210, 1220 each comprise an opening to removably receive a grid component 1250 in said opening. The openings are substantially rectangular and extend along part of the length of the bumper segments 1200, 1210. 1220, particularly along the middle portion of the C-shaped bumper sections. The grid components 1250 may be grilles that allow airflow into the engine compartment of the vehicle.

The multi-part metal bumper 1020 comprises a skid plate 1260. The skid plate 1260 protects the underside of the vehicle from damage. The skid plate 1260 is removably connected to at least one of the plurality of bumper segments 1200, 1210, 1220. In the example of FIGS. 14 to 16, the skid plate 1260 is removably connected to the plurality of bumper segments 1200, 1210, 1220 via the chassis. In other embodiments the skid plate may be removably connected to one of the plurality of bumper segments.

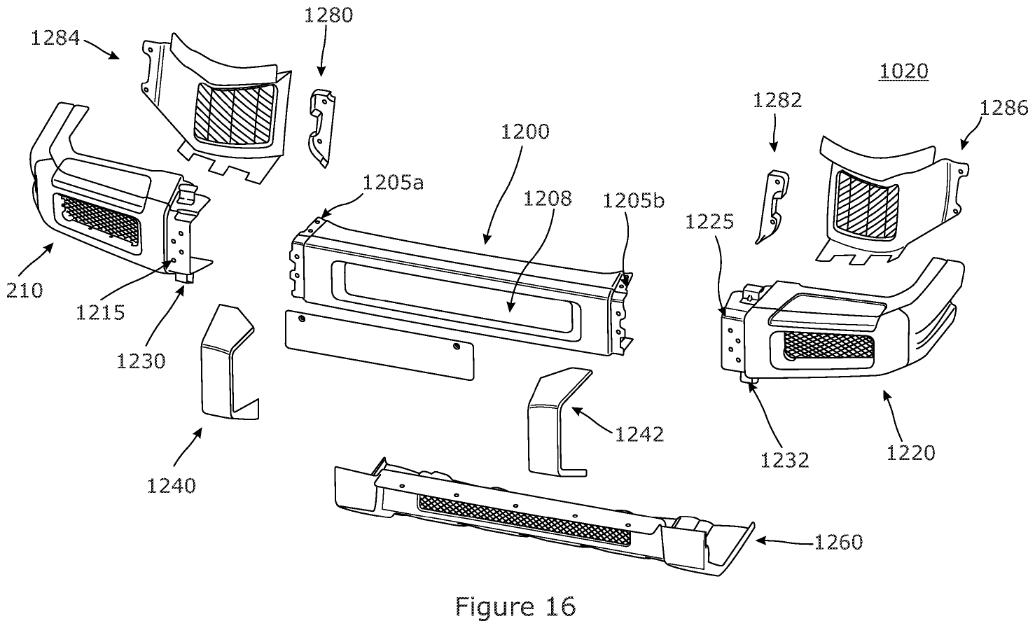

The multi-part metal bumper 1020 comprises a pair of wheel arch panels 1284, 1286 shown in FIG. 16. The wheel arch panels 1284, 1286 are removably connectable to the plurality of bumper segments. The wheel arch panels 1284, 1286 are removably connectable to the first and second side bumper segments 1210, 1220 respectively.

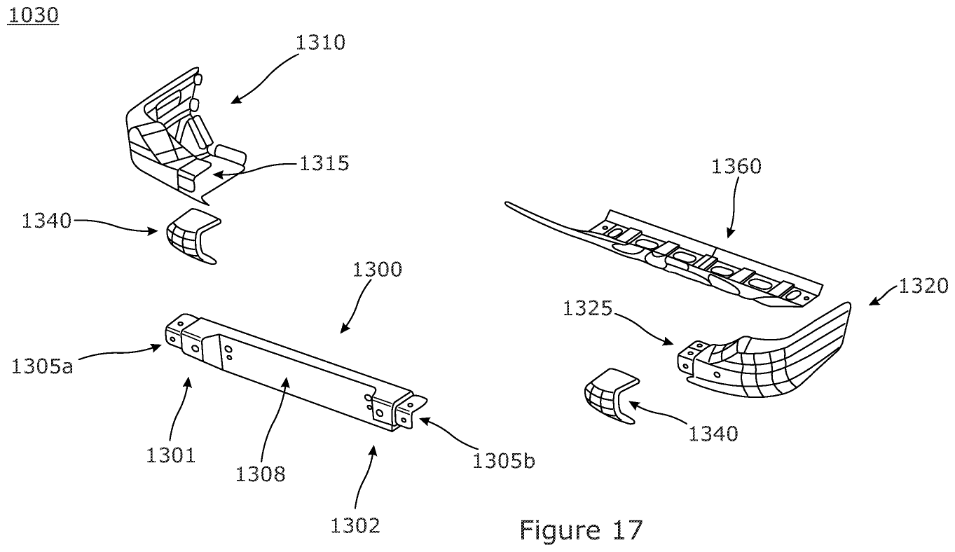

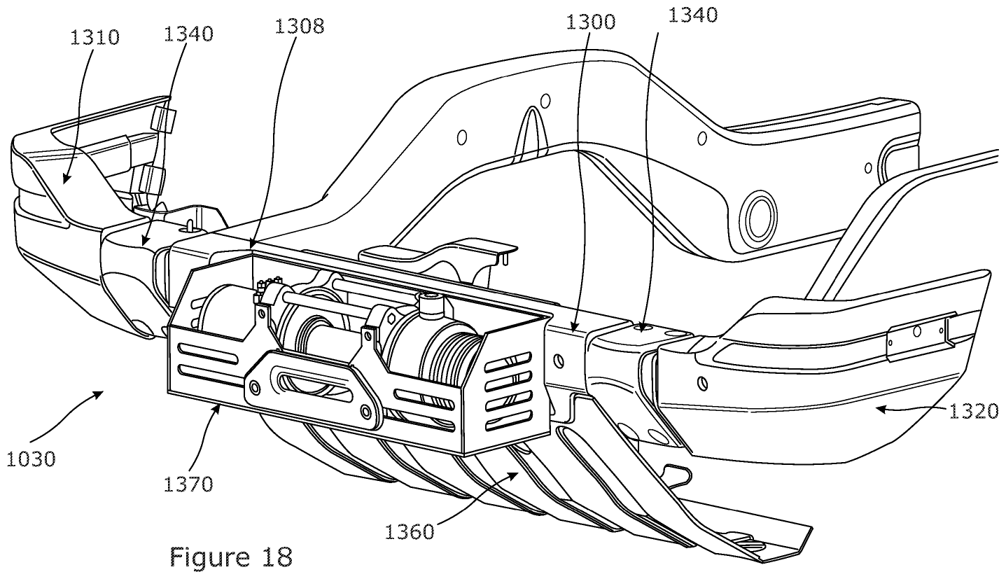

The central bumper segment 1200 comprises a recess 1208. The recess 1208 is located on the middle portion of the C-shaped, central bumper segment 1200. The recess may receive a license plate. In other embodiments, the recess may receive a winch/a winch holder similar to the winch and holder described with respect to FIGS. 17 and 18 below.

In some embodiments, the vehicle may comprise a winch located at its front end. In one example a metal winch housing of the front winch may form part of multi-part bumper. For example, the winch housing may replace the central bumper segment shown in the embodiment of FIGS. 14 to 16. In such a case, the first and second side bumper segments may be removably connected to the winch housing. In other words, the winch housing represents the central segment of this embodiment. In alternative embodiments, the winch housing may also be connected to the central bumper segment of FIGS. 14 to 16.

Turning to FIGS. 17 and 18 the multi-part metal bumper 1030 is shown to comprise a plurality of bumper segments. The plurality of bumper segments comprise a central bumper segment 1300, a first side bumper segment 1310, and a second side bumper segment 1320. Each of the bumper segments 1300, 1310, 1320 are reinforced by at least one separate reinforcement element.

The plurality of bumper segments 1300, 1310, 1320 shown in FIGS. 17 and 18 have a substantially C-shaped cross-section. The C-shaped cross-section of the bumper segments 1300, 1310, 1320 is defined by a top portion, a middle portion, and a bottom portion. In use, the top portion of the bumper segments 1300, 1310, 1320 is substantially horizontal. The middle portion of the bumper segments 1300, 1310, 1320 is substantially vertical and substantially at a 90 degree angle with respect to the top portion of the bumper segments 1300, 1310, 1320. The bottom portion of the bumper segments 1300, 1310, 1320 is angled at an obtuse angle with respect to the middle portion of the bumper segments 1300, 1310, 1320.

The central bumper segment 1300 is substantially straight along its longitudinal axis. Each of the first side segment and the second side segment 1310, 1320 is curved along its length forming a 90 degree angle corner. The plurality of bumper segments 1300, 1310, 1320 are shaped to enable the multi-part metal bumper to removable connect to the vehicle.

The first side bumper segment 1310 is connected to a first end 1301 of the central bumper segment 1300 and the second bumper segment 1320 is connected to a second end 1302 of the central bumper segment 1300, the first and second ends 1301, 1302 of the central bumper segment being arranged on opposite sides of the central bumper segment 1300.

The central bumper segment 1300 comprises a first set of connector plates 1305a at its first end 1301 and a second set of connector plates 1305b at its second end 1302, The first side bumper segment 1310 comprises a third set of connector plates 1315 at an end that is connected to the central bumper segment 1300. The second side bumper segment 1320 comprises a fourth set of connector plates 1325 at an end that is adjacent to the central bumper segment 1300. The connector plates have substantially the same functionality as described with respect to the bumper 20 shown in FIGS. 14 to 16 but the connector plates are not overlapping connector plates. Each bumper segment 1300, 1310, 1320 is removably connected to each other via the chassis, Each of the bumper segment 1300, 1310, 1320 is removably connectable to the chassis independently of the other bumper segments 1300, 1310, 1320.

The bumper 130 of FIG. 17 comprises two cover elements 1340, 1342.

The first cover element 1340 is configured to at least partly cover the first and third connector plates 1305a, 1315. A first fastening element, such as bolt, may extend through one of the fastening holes of the first cover element 1340, through the at least one fastening hole of the first connector plate 1305a, and into the chassis of the vehicle. A second fastening element may extend through the other of the two fastening holes of the first cover element 1340, through the at least one fastening hole of the third connector plate 1315, and into the chassis of the vehicle.

The second cover element 1342 is configured to at least partly cover the second and fourth connector plates 1305b, 1325. A first fastening element, such as bolt, may extend through one of the fastening holes of the second cover element 1342, through the at least one fastening hole of the second connector plate 1305b. and into the chassis of the vehicle. A second fastening element may extend through the other of the two fastening holes of the second cover element 1342, through the at least one fastening hole of the fourth connector plate 1325, and into the chassis of the vehicle.

The central bumper segment 1300 comprises a recess 1308. The recess 1308 is located on the middle portion of the C-shaped, central bumper segment 1300. The recess may receive a license plate, or a tool holder such as a winch holder as will be described in more detail with reference to FIG. 18 below.

The multi-part metal bumper 1030 comprises a skid plate 1360. The skid plate 1360 protects the underside of the vehicle from damage. The skid plate 1360 is removably connected to at least one of the plurality of bumper segments 1300, 1310, 1320. In the example of FIG. 17, the skid plate 1360 is removably connected to the central bumper segment 1300, e.g. to the bottom portion of the C-shaped central bumper segment 1300.

Turning to FIG. 18, the multi-part metal bumper 130 of FIG. 17 is shown further comprising a tool holder, particularly a winch holder 1370. The winch holder 1370 is removably connected to the bumper 1030. In detail, the tool holder 1370 is removably received within the recess 1308 of the central bumper segment 1300.

Preferences and options for a given aspect, feature or parameter of the invention should, unless the context indicates otherwise, be regarded as having been disclosed in combination with any and all preferences and options for all other aspects, features and parameters of the disclosure.

1. A recessed roof panel for a vehicle, the recessed roof panel comprising a housing with a basin and a lip portion at least partly surrounding the basin, wherein the housing is configured such that, in use, the basin extends towards an interior of a vehicle when the lip portion abuts against an exterior surface of a vehicle roof.

2. The recessed roof panel of claim 1, wherein the housing is made of plastic material.

3. The recessed roof panel of claim 1, wherein the recessed roof panel is configured to be removably attached to a vehicle.

4. The recessed roof panel of claim 1, comprising a sealing member arranged on the lip portion in such a way that, in use, the sealing member is located between the lip portion and an exterior surface of a vehicle.

5. The recessed roof panel of claim 1, comprising at least one connector piece, particularly a metal connector piece, attached to the basin of the housing.

6. The recessed roof panel of claim 5, wherein the connector piece comprises one or more fastening members extending through the basin, said one or more fastening members being configured for attachment to a frame of a vehicle.

5. The recessed roof panel of claim 5, wherein the connector piece is received within the basin and sized such that no part of the connector piece protrudes over the lip portion of the housing.

8. The recessed roof panel of claim 1, wherein the basin has a concave surface and a convex surface arranged on opposite sides of the basin, and wherein the connector piece is connected to the concave surface of the basin.

9. The recessed roof panel of claim 8, wherein the basin comprises reinforcement ribs located on the convex surface of the basin.

10. The recessed roof panel of claim 8, wherein the basin comprises one or more flange portions configured to abut against a corresponding frame of a vehicle, when in use, the one or more flange portions being arranged on the convex surface of the basin, opposite to the at least one connector piece.

11. The recessed roof panel of claim 5, wherein the connector piece comprises one or more tie-down members.

12. The recessed roof panel of claim 11, wherein the one or more tie-down members are clamps, studs, or lugs.

13. The recessed roof panel of claim 1, comprising a removable bar received within the basin.

14. The recessed roof panel of claim 1, comprising at least two connector pieces attached to the basin of the housing, wherein the removable bar is removably connected to the at least two metal connector pieces.

15-19. (canceled)

20. A vehicle comprising a tie-down system for removably securing items to the vehicle, the tie-down system being arranged on an external surface on a side, front, and/or rear of the vehicle and at least partly connected to a reinforcement structure that is arranged between the external surface and an internal surface of the vehicle.

21. The vehicle of claim 20, wherein the vehicle comprises a vehicle door, the vehicle door having an interior surface, an exterior surface, and a door cavity located between the interior and the exterior surface of the vehicle door, and wherein the reinforcement structure is arranged within the door cavity.

22. The vehicle of claim 20, wherein the tie-down system is removably connected to the reinforcement structure.

23. The vehicle of claim 20, wherein the reinforcement structure comprises at least one reinforcement plate removably attached between the interior surface and the exterior surface of the vehicle.

24-36. (canceled)

37. A multi-part metal bumper for a vehicle, the multi-part metal bumper being removably connectable to a chassis of a vehicle and comprising a plurality of metal bumper segments removably connected to each other.

38-41. (canceled)

42. The multi-part metal bumper of claim 37, wherein:
the plurality of bumper segments comprise a central bumper segment, a first side bumper segment, and a second side bumper segment, the first side bumper segment being removably connected to a first end of the central bumper segment and the second side bumper segment being removably connected to a second end of the central side, the first and second ends of the central bumper segment being arranged on opposite sides of the central bumper segment
wherein the plurality of bumper segments are removably connected to each other and/or the chassis via connector plates, and the multi-part metal bumper further comprises at least one cover element at least partially covering the connector plates of adjacent bumper segments; and
wherein at least one of the bumper segments includes a pair of connector brackets mounted on top and bottom connector plates respectively, the connector brackets each having at least one fastening hole, wherein the fastening hole of each connector bracket receives a fastening element for removably connecting the connector bracket to a corresponding cover element.

43-60. (canceled)
